(19) United States
(12) Patent Application Publication
(10) Pub. No.: US 2009/0053357 A1
(43) Pub. Date: Feb. 26, 2009

(54) Corn-based feed product

(76) Inventors: David A. Cook, Coon Rapids, MN (US); Larry J. Holy, Delano, MN (US); Roy Johnson, Maple Grove, MN (US); Ryan Lane, Rogers, MN (US); Valerie L. Linhoff, Big Lake, MN (US); Mark D. Newcomb, Independence, MN (US); Jason Shelton, Monticello, MN (US); Bruce Smith, Paris, IL (US); John Sylvester, West Salem, OH (US); Mike Van Houten, Carmel, IN (US)

Correspondence Address: Cargill Incorporated, 15407 McGinty Road West, MS 24, Wayzata, MN, 55391-2399, US

(21) Appl. No.: 12/151,736

(22) Filed: May 8, 2008

Related U.S. Application Data
(60) Provisional application No. 60/928,210, filed on May 8, 2007.

(51) Int. Cl. A23K 1/14; A23L 1/30

(52) U.S. Cl. 426/2; 426/635; 426/72

(57) ABSTRACT

This application is directed to a corn-based feed component formed from a combination of corn components. The feed components described herein generally include at least about 75 percent by weight of a combination of corn components. Generally, the corn components of the feed products are low in starch as compared to whole kernel corn, and are thus somewhat enriched in bran and germ (as determined, for example, on a dry mass basis). Typically, such feed components have a glycemic response comparable to that of rolled oats, thereby providing a source of energy that is safer than corn, and equally as safe as oats and high fat rice bran.

### CROSS-REFERENCE TO RELATED APPLICATIONS

This application claims the benefit of U.S. Provisional Application Ser. No. 60/928,210, filed May 8, 2007, and entitled CORN-BASED FEED PRODUCT, the disclosure of which is incorporated herein by reference.

### BACKGROUND

A typical feeding program for a horse consists of hay forage with an additional feed to provide supplemental vitamins, minerals, energy, and other essential nutrients. As foraging animals, horses do not typically eat large quantities of feed at one time; rather, the equine digestive system is designed to accommodate feed consumed almost constantly. However, due to time constraints and lifestyle demands, most horse owners feed 2-3 times a day, thereby causing a disruption in the natural digestive flow of the animal.

Feeds designed for performance or breeding horses are concentrated in energy and most often are high in starch. Many problems have been identified as a result of excess starch levels in horse feeds, including stomach ulcers, colic, and laminitis.

With high levels of starch in feeds, undigested starch consumed from ration feeding moves from the stomach and small intestine into the ceacum, where excess volatile fatty acids (VFAs) will be created due to the activity of the microbes consuming the undigested starch.

High levels of starch and sugars in feeds have been linked to incidents of gastric colic, laminitis leading to founder, tying up, developmental orthopedic diseases, and excessive amounts of lactic acid in the blood stream; all of which have negative impacts on a horse's performance and overall health.

Accordingly, a feed product which provides similar benefits of high-energy grains such as oats or corn without the associated negative affects would be desirable.

### SUMMARY

This application is directed to a corn-based feed product (also referred to herein as a “corn-based feed component”) formed from a combination of corn components. The feed products described herein typically include at least about 75 percent by weight of a combination of corn components; however, in some embodiments, the corn components may constitute at least about 80% by weight, at least about 85% by weight, at least about 90% by weight or at least about 95% by weight of the feed product. Generally, the combination of corn components of the feed product are low in starch as compared to whole kernel corn, and are thus somewhat enriched in bran and germ (as determined, for example, on a dry mass basis).

For example, some embodiments of a combination of corn components may include, on a dry matter basis (“DMB”), at least 9% and typically not more than about 12% protein by weight, at least 10% and typically not more than 15% crude protein by weight, at least 10% and typically not more than 12% crude protein by weight, at least 11% and typically not more than 15% crude protein by weight.

Other embodiments of a combination of corn components may include, DMB, at least 7% and typically not more than 20% fat by weight, or at least 10% and typically not more than 20% fat by weight. Still other embodiments may include, DMB, a combination of corn components with at least 9% and typically not more than 12% fat by weight, or at least 10% and typically not more than 12% fat by weight.

In still other embodiments, a combination of corn components may include at least about 2% and typically not more than 6% acid detergent fiber (“ADF”) DMB by weight, at least about 2% and typically less than 5% ADF by weight, at least about 3.0% and typically not more than 5% ADF by weight. In other embodiments, a combination of corn components may include at least about 2.5% ADF by weight, DMB.

In yet other embodiments, a combination of corn components may include, DMB, at least 8% and typically not more than 22% neutral detergent fiber (“NDF”) by weight, at least 11% and typically not more than 20% NDF by weight, and in some embodiments, at least 11% and typically less than 18% NDF by weight. In still further embodiments, a combination of corn components may include at least about 11% by weight NDF, DMB.

Still other embodiments of a combination of corn components may include, DMB, at least about 1.5% and typically not more than 4% by weight ash, or at least about 2.5% but typically not more than 3.5% by weight ash.

In some embodiments, the combination of corn components used to make the present feed products typically have a granulation of less than 1% by weight (DMB) on a 12 US mesh screen and at least 90% by weight (DMB) on a 60 US mesh screen.

Although relatively low in starch, in some feed product embodiments, a substantial portion of the starch present in the feed products is gelatinized. Typically, at least about 50% of the starch is gelatinized. Other feed product embodiments may include different percentages of gelatinized starch. For example, at least about 30% of the starch may be gelatinized in some embodiments, while in others, at least about 40% of the starch may be gelatinized. In still other embodiments, at least about 50%, at least about 60%, or at least about 70% of the starch may be gelatinized, while in other embodiments, at least about 80%, at least about 90%, or at least about 95% of the starch may be gelatinized. In some embodiments at least about 97% of the starch may be gelatinized, while in further embodiments, 100% of the starch may be gelatinized. In other embodiments, from about 60% to about 80% of the starch of a feed product is gelatinized.

Commonly, feed products described herein exhibit a lower glycemic response as compared to similarly processed whole corn products or other processed grains when tested in horses. For example, feed products may have a glycemic response less than that of rolled oats, pelleted corn, and steam-pelleted corn. In some embodiments, the feed products may have a glycemic response comparable to that of rolled oats; in other embodiments, the glycemic response of the feed product may be less than that of rolled oats. Accordingly, the feed products may provide a source of energy that is safer than corn and equally as safe as oats and high fat rice bran.

The feed products generally include different weight percentages of nutrients (as determined, for example, on a dry mass basis) as compared to whole corn or individual corn components (e.g., bran, germ, endosperm, etc.). For example, as compared to whole corn, pelleted soft corn, cracked soft corn, or heat treated soft corn, the feed products generally include a lower percentage of starch and a higher percentage of other nutrients such as ash, ADF, NDF, crude protein, and/or fat.

In some embodiments, a feed product may include a total starch content of about 30-65 weight percent; in other embodiments, the total starch content may be about 35-60 weight percent.

In some embodiments, a feed product may include about at least about 7 weight percent fat (DMB), at least about 7 to 20 weight percent fat (DMB), or at least about 7 to 15 weight percent fat (DMB). In still other embodiments, a feed product may include about 9 to 15 weight percent fat (DMB), while other embodiments may include at least about 9 to 20 weight percent fat (DMB).

Still other embodiments may include a crude protein content, DMB, of at least about 10 weight percent to 15 weight percent, at least about 11 weight percent to 15 weight percent, at least about 12 weight percent to 15 weight percent, or at least about 14 weight percent to 15 weight percent. Other embodiments may include a crude protein content, DMB, of at least about 9 weight percent to 15 weight percent, at least about 9 weight percent to 14 weight percent, or at least about 11 weight percent to 13 weight percent.

Some feed product embodiments may include a neutral detergent fiber (“NDF”) content, DMB, of at least about 12 weight percent to about 24 weight percent, or at least about 12 weight percent to 22 weight percent, or at least about 16 weight percent to 20 weight percent, or at least about 8 weight percent to 22 weight percent, or at least about 10 weight percent to 20 weight percent.

In further embodiments, some feed products may have an acid detergent fiber (“ADF”) content, DMB, of about 2 to 6 weight percent, at least about 4 weight percent to 6 weight percent or at least about 3.0 weight percent, at least about 5.0 weight percent.

Still other feed product embodiments may include an ash content, DMB, of at least about 1.5 weight percent to about 5 weight percent, or at least about 3 weight percent, and typically about 3 weight percent to 4 weight percent. Still other feed product embodiments may include an ash content of at least about 1 weight percent to about 5 weight percent, or at least about 2 weight percent, and typically about 2 weight percent to 3 weight percent.

In some embodiments, the feed product also includes an omega-3 FA source. As employed herein, “omega-3 FA source” refers to a material that includes one or more omega 3 fatty acids. The omega-3 fatty acid may be present in the omega-3 FA source as a free fatty acid, a fatty acid salt, and/or as a fatty acid ester (e.g., as a mono-, di-, and or/triacyl glycerol and/or as an ester group of a phospholipid). In some embodiments, the omega-3 FA sources desirably includes at least about 5% by weight of omega-3 fatty acid(s), such as eicosapentaenoic acid (“EPA”) and/or docosahexaenoic acid (“DHA”) as a percentage of total fatty acids. In other embodiments, the omega-3 FA source desirably includes at least about 10% by weight omega-3 fatty acids as a percentage of total fatty acids. In particular embodiments, the omega-3 FA source may include fish oil, for example de-scented or reduced scent fish oil. Typically, the omega-3 FA source is present in an amount of at least about 1 wt. % to 15 wt. % DMB of the feed product. Other embodiments include an omega-3 FA source in an amount of at least about 3 wt. % DMB of the feed product. In still other embodiments, the omega-3 FA source may be present in an amount of at least about 8 wt. % or higher (e.g., from about 10 wt. % to about 15 wt % DMB of the feed product). In some embodiments, the source of omega-3 FA may be added to the to the corn components prior to processing (e.g., prior to pelleting, extrusion or expansion). In other embodiments, the source of omega-3 FA may be added to the feed product after processing (e.g., after pelleting, extrusion or expansion). The source of omega-3 FA may be added by any number of methods; one such method is spraying onto a nugget of the corn-based feed product formed by a pelleting, extrusion or expansion operation.

In still other embodiments, the feed product may include one or more of the following: an additional fat source, such as animal fat, tallow, plant oil, and/or oilseed oil; an additional source of trace nutrients. Non-limiting examples of an additional source of trace nutrients include but are not limited to vitamins, minerals, probiotics, prebiotics, enzymes, flavor enhancers, digestive aids, direct fed microbials, organic acids, phytochemicals and nutriceuticals. Other non-limiting examples of an additional source of trace nutrients include yeast, a calcium source, a zinc source, and/or a selenium source. An illustrative example of a feed product including an additional fat source and an additional trace nutrients source is a feed product which includes about 9 weight percent oilseed oil, and about 4 weight percent trace nutrients. Another illustrative example of a feed product including an additional fat source and an additional trace nutrient source is a feed product which includes about 9 weight percent oilseed oil and about 2 weight percent yeast, about 1.5 weight percent calcium carbonate, and about 0.3 weight percent zinc and optionally, 0.05 weight percent selenium.

In some embodiments, the feed product may be a component of a complete feed. For example, the feed product may be a feed additive. In still other embodiments, the feed product may be formulated as a feed supplement or incorporated (e.g., processed) into a complete feed.

The application is also directed to methods of feeding a horse. Typical methods include feeding the horse a ration which includes an extruded, expanded, or pelleted corn-based feed product. Such extruded, expanded, or pelleted feed products generally include at least about 75 wt. % of a combination of corn components and may also include an omega-3 FA source. In some embodiments, the corn-based feed product includes a total starch content of about 30 to about 60 wt. % (DMB) and from about 5 wt. % to about 20 wt. % fat (DMB), or from about 7 wt % to about 20 wt. % fat (DMB). In particular embodiments, at least about 50% of the starch content is gelatinized starch. In other embodiments, at least about 30% of the starch content is gelatinized starch.

In other embodiments, the corn component includes a total starch content of about 30 to 60 wt. % (DMB) and from about 5 wt. % to 20 wt. % fat (DMB), or from about 7 wt % to 20 wt. % fat (DMB). In particular embodiments, at least about 30% of the starch content is gelatinized starch. In other embodiments, at least about 50% of the starch content is gelatinized starch.

The application is further directed to feed products formed by a process including pelleting, extruding or expanding a combination of corn components. Typically, such feed products are formed from a product which include at least about 75 wt. % of a combination of corn components. Such corn components can include a total starch content of about 30 to about 60 wt. % (DMB) and from about 7 wt. % to about 20 wt. % fat (DMB); typically at least about 50% of the starch is gelatinized. In some embodiments, the process may also include adding an omega-3 FA source to the pelleted, expanded, or extruded combination. In other embodiments, the combination of corn components used in the process has a granulation of less than about 1% by weight (DMB) on a 12 US mesh screen and at least about 90% by weight (DMB) on a 60 US mesh screen prior to processing via pelleting, expanding, or extruding.

In some embodiments, the feed products (feed components) described herein may exhibit a potential starch leakage into the cecum of the animal of no more than about 25 grams per kilogram of the feed component. In other embodiments, the potential starch leakage of the feed component is desirably no more than about 20 grams per kilogram of the feed component.

### BRIEF DESCRIPTION OF THE DRAWINGS

FIG. 1a shows a comparison of the glycemic response of the following unprocessed feed ingredients: cracked soft corn, whole oats and Champion Line™ (available under the trade designation “EnergX™”) corn material (an example of a combination of corn components) prior to any processing (e.g., extrusion, expansion or pelleting). The Unprocessed Champion Line corn components shown here were used to make the exemplary feed products called “Champion Line Pelleted,” “Champion Line, Expanded 1” and “Champion Line, Expanded 2” shown in FIGS. 1b-1c, and discussed elsewhere in the application.

FIG. 1b shows a comparison of the glycemic response of Champion Line Pelleted feed product (example of a feed product) with pelleted corn.

FIG. 1c shows a comparison of the glycemic response of Champion Line Expanded 1 feed product, and Champion Line Expanded 2 feed product (examples of feed products) with steam pelleted corn and rolled oats.

FIG. 2 shows a graph of AUC (Area Under the Curve) values for different feed ingredients fed to horses, including Champion Line corn components (an example of unprocessed corn components; this is the same material as Champion Line Unprocessed), Champion Line Pellet, Champion Line Expanded 1 feed product, Champion Line Expanded 2 feed product. The graph shows AUC values for both glucose and insulin.

FIG. 3 shows a graph of AUC values for different feed ingredients fed to horses adjusted for feed intake, including Champion Line corn components (an example of unprocessed corn components; this is the same material as Champion Line Unprocessed corn components), Champion Line Pellet feed product, Champion Line Expanded 1 feed product, Champion Line Expanded 2 feed product (examples of feed products). The graph show AUC values for both glucose and insulin.

FIG. 4 shows the average granulation profile for Unprocessed Champion Line corn components, an unprocessed combination of corn components.

FIG. 5 shows a graph of gelatinized starch intake (in grams) versus glucose AUC.

FIG. 6 shows a graph of glucose area under the curve (AUC) values for different feed ingredients fed to horses.

FIG. 7 shows a graph of glucose area under the curve (AUC) for horses corrected for feed intake.

FIG. 8 shows a graph of insulin area under the curve (AUC) for horses.

FIG. 9 shows a graph of insulin area under the curve (AUC) for horses corrected for feed intake.

### DETAILED DESCRIPTION

This application is directed to a corn-based feed product formed from a combination of components. Typically, such feed products have a glycemic response comparable to that of rolled oats, thereby providing a source of energy that is safer than and equally as safe as oats and high fat rice bran.

### A. Glycemic Response/Glycemic Index

The glycemic response of a particular food is a measure of the increase in blood glucose levels after a food is eaten. Some foods, especially those high in starch or sugar, generally have a large and rapid effect on blood glucose levels; blood glucose levels may increase quickly and dramatically. Such foods are termed high glycemic index foods. Other types of foods allow for a lower and slower, more steady release of glucose into the blood stream and are thus termed low glycemic index food. The glycemic index (“GI”) then, is a ranking of a food's effect on blood glucose over time relative to a control food. The GI can be defined as the area under a blood-glucose response curve over a specified time (e.g., two hours) after the ingestion of a pre-determined amount of food.

A glycemic index may be based on equal feed intake. Such a glycemic index (abbreviated herein as “GI-feed”) may be derived as follows: using the protocol described in Example 1, the area under a blood-glucose response curve for a test food (equalized for feed intake) is divided by the area under the blood-glucose response curve for a glucose standard (also equalized for feed intake). This value is then multiplied by 100 to derive the GI-feed for a particular test food. The AUC for glucose is set at 100 and the GI-feed of all other test foods are compared to the glucose standard.

Briefly, an incomplete Latin Square design was used to test the different feeds and compare them to an oral glucose standard. Horses were maintained on a low glycemic index ration (hay) throughout the duration of the study and were administered a concentrate only on testing days. For testing, horses were weighed and brought into a stall and provided their evening allotment of hay around 1600 hours. Beginning at 0630 hours, the following morning, horses were catheterized in the jugular vein using approved procedures. Blood samples were taken at −30 and −1 min prior to feeding of a test meal (1.5 g test feed/kg BW) and then at 30, 60, 90, 120, 150, 180, 210, and 240 min after the test meal. No roughage was provided during the testing period though horses had ad libitum access to water. Each blood sample was tested for glucose and insulin concentrations.

As described above, horse feeds, such as those designed for performance or breeding horses, are often concentrated in energy and are most often high in starch, and thus result in a high glycemic response in the animal. Further, as also described above, a number of other problems have been identified as a result of excess starch levels in horse feeds (e.g., stomach ulcers, gastric colic and laminitis) which may be correlated at least in part with starch leakage into the hindgut.

The feed products described herein provide the benefits of many high-energy feeds such as corn, but without the associated negative affects such as a high glycemic response as described above. More specifically, the present feed product can provide a safer source of energy than whole corn and may be equally as safe as comparables, such as oats and high fat rice bran; moreover, the glycemic response of the feed products may be comparable or lower than that of rolled oats. Thus, in addition to energy and nutritional benefits, the present feed product also can provide a more controlled glycemic response as compared to other high-energy feedstuffs.

The feed products may be formulated to provide energy for the horse in a manner that will be digested with minimal residual undigested starch while still providing a level of starch sufficient to support glycogen repletion in performance horses. This controlled level of starch creates an even supply of glucose which provides a steady source of energy, and also ensures that the starch is degraded prior to entering the ceacum, thereby reducing the negative impacts of undigested starch. Thus, glucose and insulin spikes/uptake are reduced, and a relatively stable amount of starch that is degraded before it enters the cecum is provided, thereby reducing the chances of colic and other metabolic disorders in the horse.

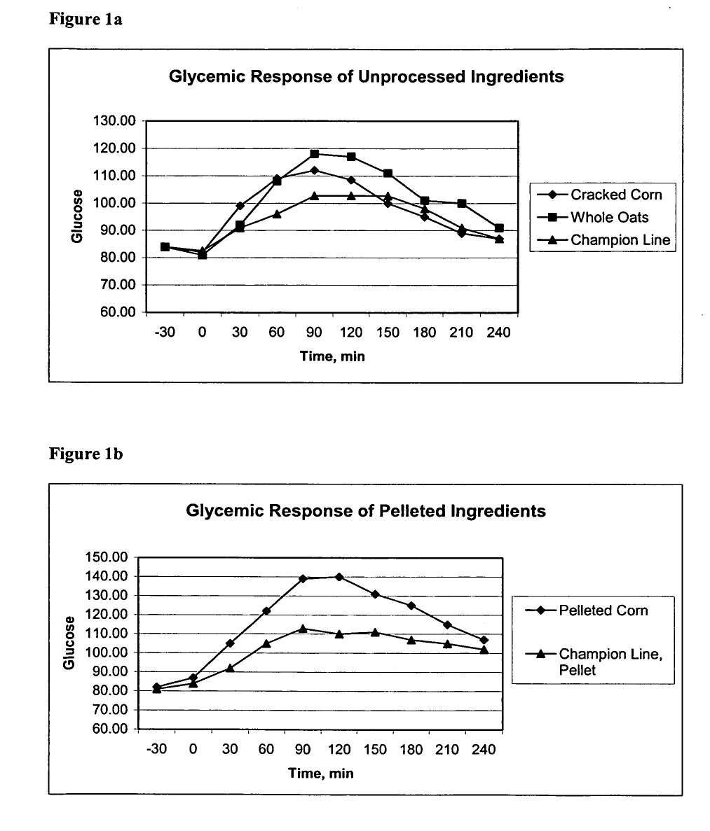

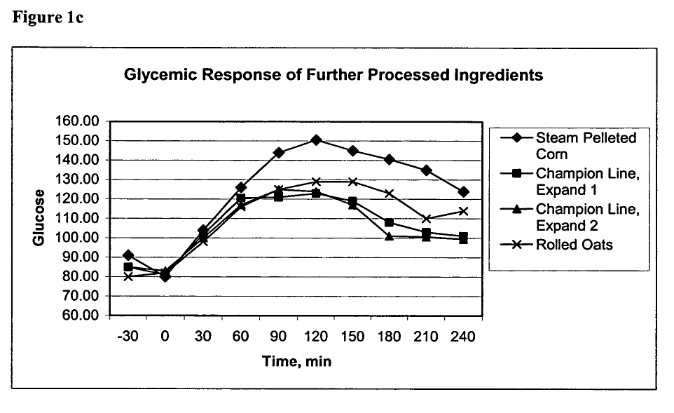

FIGS. 1a-1c show the glycemic response for a variety of unprocessed and processed grain products (see Example 1) in horses. As can be seen, generally, the feed products have a glycemic response comparable to or lower than that of rolled oats and lower than that of similarly processed corn.

### B. Corn Components

The corn components of the feed product may be produced by a fractionation process as described, for example in WO 2004/093549 (PCT/US2004/010954) and WO 2006/055489 (PCT/US2005/041190), herein incorporated by reference in their entirety.

In many embodiments, the corn used in the fractionation process is produced in accordance with an identity preservation service, such as Innovasure® IDP from Cargill, Incorporated. Under the identity preservation service, the corn seed selection, grower network, storage, handling, processing, and distribution are closely controlled in order to provide a final corn product having a desired composition.

In many embodiments, the corn selection and fractionation process are controlled in order to achieve a fumonisin level in the resulting feed product of about 5% ppm or less, for example, about 4 ppm or less, about 3 ppm or less, about 2 ppm or less, or about 1 ppm or less fumonisin. In many embodiments, the feed composition has a fumonisin level of about 2-3 ppm.

Briefly, in the fractionation process, the corn kernels are mixed with water for a time and at a temperature which is effective to lift the hulls from the endosperm of the corn kernel, but not effective for moisture to substantially penetrate into the endosperm. Germ and bran are then abrasively removed from the moistened corn kernels by rubbing the kernels against a screen or mesh. This yields throughstock and tailstock fractions (both of which are “corn components”). The throughstock fraction typically includes much of the germ and bran and some fraction of starch from the endosperm, while the tailstock fraction is endosperm-rich and higher in starch than the throughstock. The throughstock fraction is thus enriched in protein and fat and includes a lower percentage of starch as compared to the tailstock. Additional processing steps may include further separation of any bran or germ from the tailstock, and addition of that bran to the throughstock. Typically, the corn components of the feed products include the throughstock, and may also include additional bran fractions and/or germ fractions separated from the tailstock.

The corn component in a basic form may be a flowable powder created in a process as described above. In some embodiments, the corn components have a granulation of less than 1% by weight (DMB) on a 12 US mesh screen and at least 90% by weight (DMB) on a 60 US mesh screen.

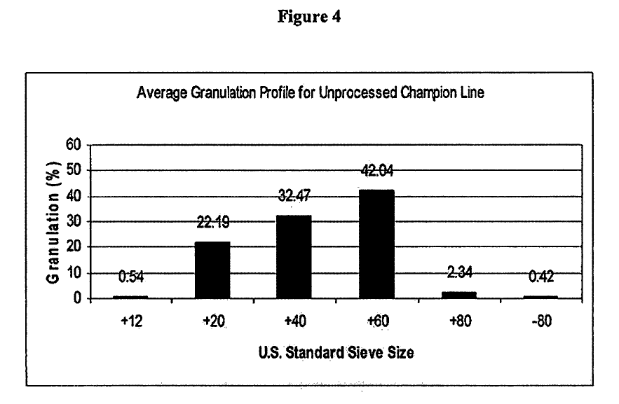

An exemplary granulation profile of a combination of corn components is shown in Table 1 and FIG. 4.

TABLE 1
Granulation profile of a combination of corn components.

| | Ro-tap Sieve Analysis (2.5 min sieve time) | | | | | | Percent | | |
|---|---|---|---|---|---|---|---|---|---|
| SAMPLE | +12 | +20 | +40 | +60 | +80 | −80 | MOISTURE | OIL | PROTEIN |
| 1 | 0.5 | 23 | 29.2 | 43.7 | 2.8 | 0.8 | 12.4 | 9.6 | 10 |
| 2 | 0.5 | 22.9 | 32.1 | 42.8 | 1.5 | 0.2 | 12.5 | 9.5 | 9.9 |
| 3 | 0.6 | 24.4 | 31.5 | 41.1 | 2.1 | 0.3 | 12.4 | 9.6 | 10 |
| 4 | 0.6 | 25 | 34.1 | 36.9 | 3.2 | 0.2 | 12.2 | 9.6 | 9.8 |
| 5 | 0.6 | 24 | 40.4 | 31.9 | 2.8 | 0.3 | 11.8 | 9.9 | 10.1 |
| 6 | 0.5 | 19.7 | 31.9 | 44.9 | 2.4 | 0.6 | 12.2 | 9.6 | 9.9 |
| 7 | 0.5 | 21.3 | 32.2 | 44.3 | 1.4 | 0.3 | 12.4 | 9.4 | 9.9 |
| 8 | 0.5 | 19.6 | 30.8 | 45.8 | 2.9 | 0.4 | 12.4 | 9.5 | 9.9 |
| 9 | 0.5 | 20.8 | 31.6 | 43.8 | 2.7 | 0.6 | 12.5 | 9.4 | 9.7 |
| 10 | 0.6 | 21.2 | 30.9 | 45.2 | 1.6 | 0.5 | 12.5 | 9.5 | 9.9 |
| Average | 0.54 | 22.19 | 32.47 | 42.04 | 2.34 | 0.42 | 12.5 | 9.4 | 9.8 |

This basic product (e.g., a combination of corn components in the form of a flowable powder) may then be extruded, expanded or pelleted (described in more detail below) to form the feed products.

Processing such as extruding, expanding and pelleting the combination of corn components gelatinizes the starch which improves digestibility and also improves storage life by reducing enzyme activity. The product may be cooled after extrusion, and then sized to meet feeding requirements, or the product may be further treated with an omega-3 FA source, other oils or fats, additional trace nutrients, vitamins, and/or flavor enhancers. Ingredients such as omega-3 FA, other oils or fats, additional trace nutrients, vitamins, and/or flavor enhancers may be added to the basic form corn components before and/or during processing, or may be added to the feed product after processing.

The nutritional composition of the corn components may vary with the variety or type of corn, the milling process, and the combination of corn components. Such variances are well known to those skilled in the art. The typical nutritional composition of whole corn and for comparison, the typical nutritional composition of corn components, as weight percent, on a dry matter basis (“DMB”) is shown in Table 2.

TABLE 2
Typical mix of corn components.

| | Typical mix of “corn | |
|---|---|---|
| | components* | Whole corn |
| | (weight percent | (weight percent |
| | DMB) | DMB) |
| Crude Protein | 10-12% | 8-10% |
| Fat | 8-12% | 3-4% |
| Ash | 2-4% | 1.0-1.5% |
| NDF | 14-22% | 8-11% |
| ADF | 3.0-5.0% | 2-3% |

*Typical mix of “corn components”: the listed nutrients for corn components which can be used to make the present corn-based feed compositions.

The nutritional information of three exemplary formulations (shaded boxes) of the feed product (called Champion Line Expanded 1, Champion Line Expanded 2 and Champion Line Pelleted, also shown in FIG. 1) are provided below as non-limiting examples in Table 3. Nutritional information for unprocessed corn components (called Champion Line Unprocessed, also shown in FIG. 1) is also provided. Note that the Champion Line Unprocessed material was used to make the Champion Line Expanded 1, Champion Line Expanded 2 and Champion Line Pelleted. Comparison with the nutritional information of different whole corn compositions indicates that the feed product is lower in starch, but higher in ash, ADF, NDF, crude protein and fat.

TABLE 3
Comparison of corn nutrients with nutrients of five feed product
formulations.

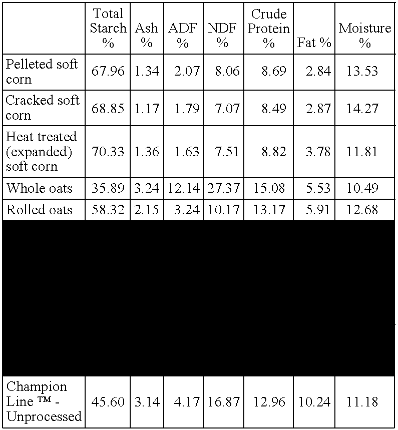

Another example of the nutrient composition of unprocessed corn components is as follows.

### Example of Corn Components

| Nutrient | Percentage |
|---|---|
| Protein | 10 |
| Fat | 10 |
| Moisture | 10 |
| Total Starch | 48 |
| Fiber | 3 |

As used herein, “wt. % (DMB)” refers to the percentage of a particular component, ingredient or nutrient as measured on a dry matter basis.

### C. Other Ingredients

In some embodiments, the feed product includes a source of omega-3 fatty acids (“omega-3 FA” source) such as fish oil. As described above, an omega-3 FA source refers to a material that includes one or more omega-3 fatty acids. The omega 3 fatty acid may be present in the omega-3 FA source as a free fatty acid, a fatty acid salt as a fatty acid ester as a mono-, di-, glycerol and/or as an ester group of a phospholipid).

Non-limiting examples of omega-3 FA sources include, fish and fish products cold water fish such as salmon, herring, chub, smelt, whitefish, burbot, lake trout and mackerel), fish oil, menhaden oil, and algae. Omega-3 fatty acids unique to fish include DHA and EPA; typically, preferred sources of omega-3 FA include at least about 5% by weight of the total fatty acids as EPA and DHA, while in other embodiments, the omega-3 FA source desirably includes at least 10% by weight of the total fatty acids as EPA and DHA. Other sources of omega-3 FA, such as plant sources, may also be used. For example, the omega-3 fatty acid, linolenic acid, is found in high quantities in plants, such as flaxseed oil, linseed oil, borage oil, perilla oil, and canola oil.

Omega-6 fatty acids may also be added to the feed products. Exemplary omega-6 fatty acid sources include but are not limited to vegetable oils such as corn, cottonseed, soybean, safflower, and sunflower oil. In some embodiments, the oils include the omega-6 fatty acid linoleic acid.

Feed product formulations including an omega-3 fatty acid source can provide a controlled starch and sugar source as well as a means of delivering 3 fatty acid in a form that is both convenient for the horse owner and accepted by the horse.

Specifically for horses, long-chain omega-3 fatty acids have been linked to improved hoof quality, improved coat, decreased muscle stiffness, and decreased joint stiffness. In addition, it is hypothesized that the omega-3 fatty acids, specifically DHA and EPA, which are found in the fish oil and reduced scent fish oil, can improve the reproductive efficiency of horses.

The source of omega-3 FA may be added to the corn components before or after processing (e.g., extruding, pelleting or texturing) the corn components. Preferably, the source of omega-3 FA is added to the corn components after processing. The extruded or pelleted or textured corn components may be cooled prior to omega-3 FA application, or the omega-3 FA source may be added to the corn components while still warm.

The omega-3 FA source may be applied to the corn components by any number of conventional means. One such means is spraying.

The resulting feed product may also be supplemented with added fats, oils, nutrients, vitamins, minerals, enhancers, and/or flavorings to enhance nutrient composition and to improve palatability.

In some feed product embodiments an additional source of fat is added. As used herein, an “additional source of fat” is meant to include any source of fat that is digestable and consumable, or can be processed to be digestable and consumable, by the animal to which it is to be fed. Non-limiting examples include oilseed oil, other plant oils, animal fats, tallows, and sources that include omega-3 fatty acids.

In some feed product embodiments, an additional source of trace nutrients is added. “Additional sources of trace nutrients” as used herein is meant to include a variety of sources of trace nutrients including, but not limited to, vitamins, minerals, probiotics, prebiotics, enzymes, flavor enhancers, digestive aids, direct fed microbials, organic acids, phytochemicals, nutriceuticals, etc.

Certain feed products and feed embodiments are provided in Examples 3-8.

### D. Extrusion and Pelleting

The corn components of the feed products may be extruded, expanded, or pelleted by methods well known in the art as described in the 2005 edition of Feed Manufacturing Technology V., Eileen K. Schofield (Technical Editor), American Feed Industry Association, Arlington, Va., and earlier editions. During extrusion, expansion, or pelleting, the starch is gelatinized which improves digestibility. Additionally, extrusion, expansion, or pelleting improves the storage life of the product by reducing enzyme activity (e.g., lipase activity). Extrusion, expansion, and pelleting processing conditions (e.g., temperature, pressure and moisture) may be controlled to produce varying levels of starch gelatinization.

Gelatinized starch values of exemplary processed and unprocessed grains, corn components, and feed products can be seen in Table 4. Processing the corn components to yield feed product (Champion Line™ Pellet feed product, Champion Line Expanded 1 feed product, Champion Line Expanded 2 feed product) either by expansion, extrusion, or pelleting has a significant effect on the gelatinized starch. Pelleting increases gelatinized starch percentages, while expansion and extrusion show an even greater increase.

TABLE 4
Total starch and gelatinized starch analysis.

| | Total | Gel starch, % | Gel starch, % |
|---|---|---|---|
| Ingredient | Starch, % | Total Starch | Diet |
| Cracked Corn | 68.6 | 18.7 | 12.8 |
| Pelleted corn | 67.9 | 42.0 | 28.5 |
| Pelleted steam processed | 68.0 | 54.8 | 37.3 |
| corn | | | |
| Whole Oats | 38.7 | 26.2 | 10.1 |
| Rolled Oats | 54.1 | 30.7 | 16.6 |
| High Fat Rice Bran | 27.8 | 57.3 | 16.0 |
| Champion Line - | 44.4 | 23.4 | 10.4 |
| Unprocessed | | | |
| Champion Line - Pellet | 44.0 | 31.6 | 13.9 |
| Champion Line - | 42.6 | 81.1 | 34.5 |
| Expanded 1 | | | |
| Champion Line - | 42.5 | 60.0 | 25.5 |
| Expanded 2 | | | |

Champion Line ™ Unprocessed = example of corn components; also shown in FIG. 1 and Table 3.
Champion Line ™ Pellet, Expanded 1 and Expanded 2 = examples of feed product, also shown in FIG. 1 and Table 3.

The term “pellet” may refer to a product made using a pellet mill, expander, extruder, or like device. For example, the feed product may be processed in pellet form by forcing the combination of corn components through an orifice and dividing the output into segments. This may be done by either an extrusion process, expansion process or a pelletizing process. Thus, it should be understood that use of the term “pellet” is not meant to imply or require that any particular process be used to prepare the feed product. Rather, “pellet” is intended to refer to the final solid conglomerated form of the feed product. The term “nugget” is also used herein to refer to the final solid conglomerated form of the feed product.

### E. Different Forms and Formulations

In one embodiment, the feed product would include an extruded, expanded, or pelleted product containing the high bran/high germ fraction corn components produced by the milling methods described above. The glycemic response of the feed product would be comparable to that of rolled oats. The feed product may or may not be combined with other ingredients.

In another embodiment, the feed product would include an extruded, expanded, or pelleted product containing the high bran/high germ fraction corn components produced by the milling methods described above, and sprayed with a fish oil or other omega-3 FA source after pelleting, expansion, or extrusion. The fish oil may or may not be treated to ameliorate the scent. Alternatively, the omega-3 FA source may be incorporated prior to pelleting, expansion, or extrusion. The glycemic response of the feed product would be comparable to that of rolled oats and would additionally include the benefits the omega-3 fatty acid profile. This product may or may not be combined with other ingredients.

When combined with fish oil or other omega-3 FA source and/or other ingredients, the feed product is typically processed into a feed nugget capable of delivering nutrients as a concentrate which would enhance the performance of working and breeding animals through the supplementation of omega-3 and fatty acid. The concentration of omega-3 fatty acids of this product would allow the supplementation amount to be relatively small, thereby providing an element of convenience for the horse owner along with the psychological value of added safety.

In another embodiment, the high bran/high germ fraction corn components produced by the milling methods and described above and would be incorporated into an extruded, expanded, pelleted, or textured feed product that would meet the majority of the horse's nutritional needs. The glycemic response of the feed product would be comparable to that of rolled oats. Such feed products may or may not be combined with other ingredients, and may or may not include fish oil.

In another embodiment, feed products or feeds would be specifically formulated to meet target physiological responses in an animal. The physiological responses, particularly glycemic response, may be modeled and products and/or feeds may be formulated to meet specific upper and lower criteria for the physiological response would be formulated.

The corn components may be pelleted, expanded, extruded, or made into collets to be utilized as a feed product in complete feeds or as a feed itself. Further processing steps, such as grinding to form a feed powder, may also be performed.

The feed product may be a feed supplement or feed additive. Typically, a feed additive is pre-mixed into or combined with a complete feed, while a supplement is typically a “stand alone,” separate product that an owner may add to a feed allotment (e.g., by top dressing).

The product may be of food grade, which adds psychological value to the customer, as most horse owners identify their horses as close members of the family. An additional benefit of the product is the system within which it is produced. The system supports a reduced risk of mycotoxin development on the feedstock corn grain. This is especially important to the horse as they are especially susceptible to fumonisin.

### F. EXAMPLES

### Example 1

A 16×16 incomplete Latin Square design was used to test 17 different feeds and compare them to an oral glucose standard. The 16 horses consisted of eight two-year-olds (half fillies and half geldings) and eight mature horses (12 to 16 years of age, half mares and half geldings). Horses were maintained on a low glycemic index ration (hay) throughout the duration of the study and were administered a concentrate (test feed) only on testing days. For testing, horses were weighed and brought into a stall and provided their evening allotment of hay around 1600 hours. Beginning at 0630 hours the following morning, horses were jugular catheterized using approved procedures. Blood samples were taken at −30 and −1 min prior to feeding of a test meal (1.5 g test feed/kg BW) and then at 30, 60, 90, 120, 150, 180, 210, and 240 min after the test meal. Glucose was administered by an oral drench at 0.25 g dextrose/kg BW. The GI-feed calculations were made based on the AUC with feed intake accounted for in the calculations. Basically, the area under a blood-glucose response curve for a test food (equalized for feed intake) was divided by the area under the blood-glucose response curve for a glucose standard (also equalized for feed intake). This value was then multiplied by 100 to derive the GI-feed for a particular test food. The AUC for glucose was set at 100 and all other ingredients were based on their relative ranking to the glucose standard.

No roughage was provided during the testing period though horses had ad libitum access to water. Each blood sample was tested for glucose and insulin concentrations. Results are shown below in Tables 4 and 5 and in FIGS. 1, 2, and 3.

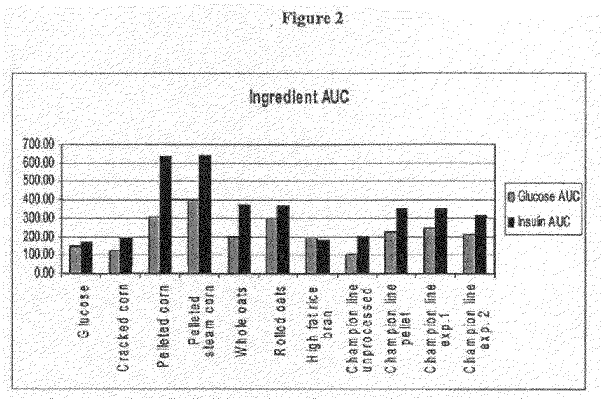

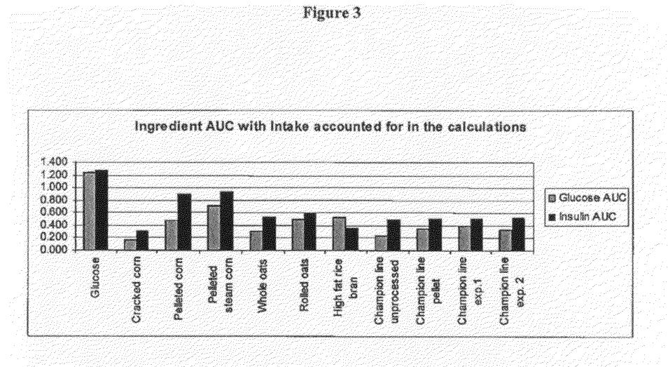

Table 4 and FIG. 2 indicate the overall Area under the Curve (“AUC”) for glucose and insulin in horses fed the different ingredients. Table 5 and FIG. 3 indicate the overall AUC for glucose and insulin in horses fed the different ingredients and adjusted for feed intake. Data was considered significant at P<0.10.

Overall, horses fed cracked corn or the unprocessed Champion Line™ corn components (an example of a combination of corn components) had the lowest glucose AUC relative to horses fed any other ingredient (besides glucose) in the trial. Horses fed whole oats had a higher glucose AUC relative to those fed cracked corn or unprocessed Champion Line corn components. Horses fed pellet steam corn had a higher glucose AUC relative to horses fed any other ingredients. Horses fed pellet corn and rolled oats had higher glucose AUC relative to those fed any other ingredient besides pellet steam corn. When similar processing occurred (pellet corn versus Champion Line Pellet feed product or pellet steam corn versus Champion Line Expanded 1 or 2 feed product) horses fed the Champion Line feed product had lower glucose AUC relative to horses fed whole corn products (see entries for cracked corn, pellet corn and pellet steam corn in Table 5). When similar processing occurred between oats and Champion Line feed product, horses fed Champion Line feed product had lower glucose AUC (whole oats versus unprocessed Champion Line feed product; rolled oats versus Champion Line Expanded 1 or 2 feed product). Similar responses were seen in the insulin AUC results.

TABLE 5
AUC of different feed ingredients fed to horses.

| Dietary Treatment | AUC, glucose | AUC, Insulin |
|---|---|---|
| Ingredient Results | mg/dliter | Uldliter |
| Glucose | 145.12^{de} | 170.00 ^{c} |
| Cracked Corn | 122.29 ^{e} | 188.37 ^{c} |
| Pelleted corn | 308.92 ^{b} | 632.85 ^{a} |
| Pelleted steam corn | 404.11 ^{a} | 640.84 ^{a} |
| Whole Oats | 197.76 ^{c} | 369.39 ^{b} |
| Rolled Oats | 301.83 ^{b} | 367.27 ^{b} |
| High Fat Rice Bran | 193.20^{cd} | 182.37 ^{c} |
| Champion Line Unprocessed | 103.97 ^{e} | 199.47 ^{c} |
| Champion Line Pellet | 226.62 ^{c} | 353.09 ^{b} |
| Champion Line Expanded 1 | 247.05 ^{c} | 350.79 ^{b} |
| Champion Line Expanded 2 | 208.91 ^{c} | 312.99 ^{b} |

VARIATION

| | | |
|---|---|---|
| SEM | 28.27 | 77.43 |

STATISTICS

| | | |
|---|---|---|
| Age | 0.3361 | 0.0017 |
| Trts | <.0001 | <.0001 |
| Age*trts | 0.9667 | 0.0012 |

Table 6 and FIG. 3 show the glucose and insulin AUC data taking into account the differences in feed intake. Horses fed cracked corn, whole oats, or the unprocessed Champion Line™ corn components had the lowest glucose AUC relative to horses fed any other ingredient in the trial. Horses fed pellet steam corn had a higher glucose AUC relative to horses fed any other ingredients besides glucose. When similar processing occurred (pellet corn versus Champion Line Pellet feed product or pellet steam corn versus Champion Line Expanded 1 or Expanded 2 feed product) horses fed the Champion Line feed product had lower glucose AUC relative to horses fed corn products. When similar processing occurred between oats and Champion Line feed products, horses fed Champion Line feed products had numerically lower glucose AUC (whole oats versus unprocessed Champion Line™ corn components; rolled oats versus Champion Line Expanded 1 or 2 feed product). Similar responses were seen in the insulin AUC results.

TABLE 6
AUC (adjusted for feed intake) of different
feed ingredients fed to horses.

| Dietary Treatment | AUC, glucose | GI- | AUC, Insulin |
|---|---|---|---|
| Ingredient Results | mg/dliter | feed | U/dliter |
| Glucose | 1.245 ^{a} | 100 | 1.280 ^{a} |
| Cracked | 0.183 ^{d} | 14.66 | 0.301 ^{c} |
| Pelleted corn | 0.470 ^{c} | 37.70 | 0.893 ^{b} |
| Pelleted steam corn | 0.716 ^{b} | 57.53 | 0.932 ^{b} |
| Whole oats | 0.300 ^{d} | 24.05 | 0.534 ^{c} |
| Rolled oats | 0.486 ^{c} | 39.06 | 0.587 ^{c} |
| High fat rice bran | 0.532 ^{c} | 42.72 | 0.370 ^{c} |
| Champion Line Unprocessed | 0.237 ^{d} | 19.00 | 0.493 ^{c} |
| Champion Line Pellet | 0.357 ^{c} | 28.67 | 0.509 ^{c} |
| Champion Line Exp. | 0.357 ^{c} | 30.13 | 0.509 ^{c} |
| Champion Line Exp. 2 | 0.341 ^{c} | 27.42 | 0.522 ^{c} |

VARIATION

| | | |
|---|---|---|
| SEM | 0.097 | 0.144 |

STATISTICS

| | | |
|---|---|---|
| Age | 0.4571 | 0.0055 |
| Trts | <.0001 | <.0001 |
| Age*trts | 0.0951 | 0.0372 |

*GI-feed = glycemic index based on equal feed intake as described in Example 1.

These data support the conclusion that with similar processing, horses fed Champion Line feed products have lower glycemic and insulin responses relative to those fed some of the other corn products. Also, horses fed Champion Line™ feed products had similar if not slightly better glycemic and insulin responses relative to those fed oat products, especially when these products were similarly processed.

### Example 2

Starch Ileal Digestibility. Ileal cannulated pigs were used in this study. A cannula was surgically placed at the ileal-cecal junction in pigs using approved procedures. Treatment diets were fed to pigs on an equal starch basis. The test diets were fed for 3 days and the ileal contents were collected at the end of the 3 days. Test contents were collected for 1 day. Then a common diet was fed for 4 days. Diets were ˜99% test ingredient with added vitamins, minerals, and titanium dioxide (indigestible marker). Ileal contents were freeze-dried and then analyzed for starch and titanium to determine the digestibility of the starch in each ingredient. For calculation of digestibility all diets were also analyzed for titanium and starch.

Starch digestibility is shown in Table 7. Starch digestibility was measured by measuring the amount of starch intake and the amount of starch found in the terminal ileum. Starch leakage values were determined by calculating the possible starch left over after eating 10 lbs of each respective product. For starch digestibility pellet corn had the lowest (P<0.05) digestibility relative to all products except for Champion Line™ Expanded 2 feed product. Starch digestibility for all other products was similar. Possible starch leakage to the hindgut was lower (P<0.05) for Champion Line Pellet feed product relative to cracked corn or pellet.

TABLE 7
Starch digestibility of corn and Champion Line feed products.

| | | Starch | Starch Intake per | Digestible | Leakage, lbs |
|---|---|---|---|---|---|
| | Dietary | Digestibility, | 10 lbs of | starch, per 10 | (per 10 lb |
| Treatment | Starch, % | % | material, lbs | lbs of material | intake) |
| Cracked | 65.89 | 94.93 | 6.589 | 6.254 | 0.33 |
| Corn | | | | | |
| Pellet Corn | 62.24 | 94.42 | 6.224 | 5.877 | 0.35 |
| Pellet Steam | 73.78 | 96.90 | 7.378 | 7.149 | 0.23 |
| Corn | | | | | |
| *CL | 46.19 | 96.24 | 4.619 | 4.445 | 0.17 |
| Unprocessed | | | | | |
| CL Pellet | 45.52 | 98.23 | 4.552 | 4.471 | 0.08 |
| CL Exp. 1 | 45.17 | 95.82 | 4.517 | 4.328 | 0.19 |
| CL Exp. 2 | 43.39 | 94.93 | 4.339 | 4.119 | 0.22 |

*CL = Champion Line Unprocessed corn components, CL Pellet = Champion Line Pellet feed product, CL Exp. 1, CL Exp. 2 = Champion Line Expanded 1 and Expanded 2 feed product.

Though the data shows relatively small difference in the percent digestibility between the corn sources, as noted above, when these data are reviewed based on a potential starch leakage factor, or based on the amount of starch that may enter the ceacum and large intestine, there is more potential for starch leakage with the corn than with the Champion Line feed products due to the higher level of starch in corn. Also, volatile fatty acid production should show the changes in small and large intestine fermentation between these feed options.

Thus, when each animal is fed 10 lbs of each product, more starch is available to the ceacum and large intestine from the corn products than from the Champion Line feed products. This results in a 42% decrease in potential starch leakage in the Champion Line Expanded 1 feed product versus the cracked corn and a 31% decrease in potential starch leakage in the Champion Line™ Expanded 2 feed product versus the cracked corn. (See Table 7).

Thus, even though cracked corn has a lower glycemic index based on feed intake (GI-feed) (see Table 6), there is a higher potential for starch leakage based on the digestibility data; as discussed above, even though starch digestibility of Champion Line feed products is roughly the same as corn, the higher starch levels in corn actually increase the chance of starch leakage (by ˜30-40%). Accordingly, an evaluation of both glycemic response and potential starch leakage illustrates that Champion Line™ feed products provide advantages over other feed grains.

The gelatinized starch data in Table 4 provides evidence as to why no great differences were noted between Champion Line Expanded 1 feed product versus Champion Line Expanded 2 feed product for glycemic response, insulin response, and starch digestibility. The amount of gelatinized starch was slightly lower in the Expanded 2 product versus the Expanded 1. When the ingredients are more harshly processed (steam pellet for the corn versus Expanded for the Champion line feed product, for example), the amount of gelatinized starch as a percentage of starch was higher for the Champion Line feed products thus making the overall amount of gelatinized starch equal to that of corn. This indicates that even though the overall digestibility was similar between the two products the rate of digestion may be different. When compared to rolled oats, Champion Line feed product Expanded 1 or 2 had more gelatinized starch.

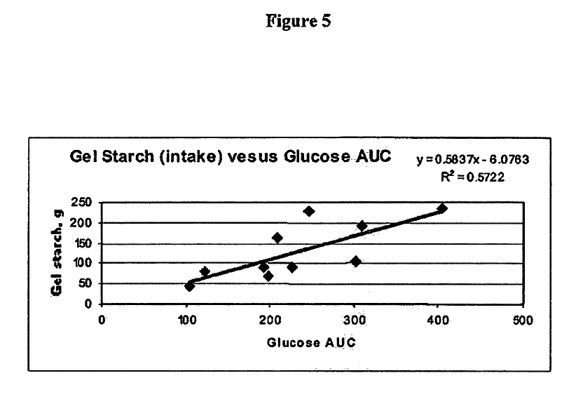

A graph showing the correlation between gelatinized starch intake and glucose AUC is shown in FIG. 5.

### Example 3

Example 3 provides an exemplary feed product including fish oil and additional sources of trace nutrients. In this example, all components except the fish oil are combined prior to processing. The combined components are then extruded, expanded, or pelleted. The fish oil is added to the feed product (e.g., by spraying) after extrusion, expansion, or pelleting. In this example, trace nutrients may include but are not limited to vitamins, minerals, probiotics, prebiotics, enzymes, flavor enhancers, digestive aids, direct fed microbials, organic acids, phytochemicals, nutriceuticals, etc. In some embodiments, yeast, a calcium source such as calcium carbonate, a zinc source, such as Zinpro, and selenium may be used. Illustrative percentages of these trace nutrient are: 2%, 1.5%, 0.3% and 0.05% respectively.

### Exemplary Feed Product A

| Raw Material | Percentage |
|---|---|
| Champion Line ™ Unprocessed | 84 |
| corn components | |
| Fish Oil | 2 |
| Soybean Oil | 9 |
| Trace Nutrients | 5 |

### Example 4

Example 4 provides an exemplary feed product including an encapsulated omega-3 source and additional sources of trace nutrients. In this example the components are combined and are then extruded, expanded, or pelleted. Trace nutrients may include but are not limited to vitamins, minerals, probiotics, prebiotics, enzymes, flavor enhancers, digestive aids, direct fed microbials, organic acids, phytochemicals, nutriceuticals, etc. Some examples of trace nutrients may include calcium, zinc, selenium. Yeast may also be added to provide additional nutrients and flavoring. Illustrative percentages of exemplary trace nutrients are: calcium carbonate 0.95%, ZinPro 0.3%, Vitamin E, 0.05% and Selenium 0.05%. Yeast may also be added at 2%.

### Exemplary Feed Product B

| Raw Material | Percentage |
|---|---|
| Champion Line ™ Unprocessed | 88 |
| corn components | |
| Omega-3 Source | 6 |
| Soybean Meal | 1.75 |
| Trace Nutrients | 4.25 |

### Example 5

Example 5 provides an exemplary feed product including an omega-3 source and additional sources of trace nutrients. In this example, all components except the omega-3 source are combined prior to processing. The combined components are then extruded, expanded, or pelleted. The omega-3 source is added to the feed product (e.g., by spraying) after extrusion, expansion, or pelleting. Trace nutrients may include but are not limited to vitamins, minerals, probiotics, prebiotics, enzymes, flavor enhancers, digestive aids, direct fed microbials, organic acids, phytochemicals, nutriceuticals, etc.

### Exemplary Feed Product C

| Raw Material | Percentage |
|---|---|
| Champion Line ™ Unprocessed | 82 |
| corn components | |
| Omega-3 Source | 12 |
| Soybean Meal | 1.75 |
| Trace Nutrients | 4.25 |

### Example 6

Example 6 provides feed formulations. All of the feed formulations in this example include a Champion Line™ feed product (abbreviated “CL” in Table 8). In some feed formulations, unprocessed Champion Line corn components are combined with other ingredients and then the combination of ingredients is processed (extruded, expanded, or pelleted). In other formulations, (as illustrated here) Champion Line corn components may be expanded, extruded, or pelleted and the processed nugget (e.g., Champion Line feed component) is then combined with the other ingredients. Fats and oils may be added prior to or after processing of the Champion Line corn components or the Champion Line feed formulation.

Seven different feed types are presented: Youth, Performance (“Perf”), Maintenance (“Main”), Senior (“SR”), All Around (“AA”) Weight Management (“WM”) and Textured (“T”). The percentage of each component per feed type is presented below in Table 8.

TABLE 8
Feed formulations

| | | | | | | | | Suggested | |
|---|---|---|---|---|---|---|---|---|---|
| | Percent | | | | | | | Ranges | |
| Ingredient | Youth | Perf | Main | SR | AA | WM | T | Min | Max |
| CL | 46.6 | 16 | 15 | 28 | 9.5 | 2.6 | 46.6 | 0 | 60 |
| Grains | 1 | 5 | 0 | 0.25 | 0.25 | 43 | 1 | 0 | 60 |
| Grain By-products | 25 | 52.5 | 29.5 | 30 | 59.95 | 22.5 | 25 | 10 | 80 |
| Protein Products | 11.9 | 5.5 | 3.75 | 5.5 | 0.25 | 4 | 11.9 | 0 | 20 |
| Fats & Oils | 0 | 1 | 1.75 | 2.25 | 0.05 | 6.2 | 0 | 0 | 8 |
| Fiber Sources | 6 | 11.5 | 26.2 | 26 | 12.5 | 6.26 | 6 | 0 | 35 |
| Vitamins, Minerals, | 9.5 | 8.5 | 23.8 | 8 | 17.5 | 15.44 | 9.5 | 0 | 30 |
| Enhancers | | | | | | | | | |
| Sum | 86 | 53.4 | 84 | 85 | 72 | 90.5 | 97.4 | | |

Grains may include, but are not limited to, one or more of the following: corn, soybeans, oats, barley, sorghum, wheat, rye and rice. Grain by-products may include, but are not limited to, one or more of the following: Wheat midds, distillers grains, corn gluten meal, corn gluten feed, high fat rice bran, malt sprouts, oat by-products, and brewers rice. Protein sources may include, but are not limited to, one or more of the following: SBM and canola meal. Fats and oils may include, but are not limited to, one or more of the following: soy oil, corn oil, fish oil, canola oil, animal fat, linseed oil, and rice oil. Fiber sources may include, but are not limited to, one or more of the following: alfalfa, barley products, beet pulp and soy hulls. Vitamins, minerals and enhancers may include, but are not limited to, one or more of the following: minerals, vitamins, digestive aids, flavor agents, prebiotics, probiotics, direct fed microbials, nutriceuticals, phytochemicals, enzymes, organic acids, molasses, and stabilizers.

### Example 7

Glycemic response horse trial 2. A 12×12 incomplete Latin Square design was used to test 12 different feeds and compare them to an oral glucose standard. Horses were maintained on a low glycemic index ration (hay) throughout the duration of the study and were administered a concentrate (test feed) only on testing days. For testing, horses were weighed and brought into a stall and provided their evening allotment of hay around 1600 hours. Beginning at 0630 hours the following morning, horses were jugular catheterized using approved procedures. Blood samples were taken at −30 and −1 min prior to feeding of a test meal (fed to provide 1 kcal DE/kg of BW) and then at 30, 60, 90, 120, 150, 180, 210, and 240 min after the test meal. Glucose was administered by an oral drench at 0.50 g dextrose/kg BW. The GI-feed calculations were made based on the AUC with feed intake accounted for in the calculations. Basically, the area under a blood-glucose response curve for a test food was divided by the area under the blood-glucose response curve for a glucose standard. This value was then multiplied by 100 to derive the GI-feed for a particular test food. The AUC for glucose was set at 100 and all other ingredients were based on their relative ranking to the glucose standard.

No roughage was provided during the testing period though horses had ad libitum access to water. Each blood sample was tested for glucose and insulin concentrations.

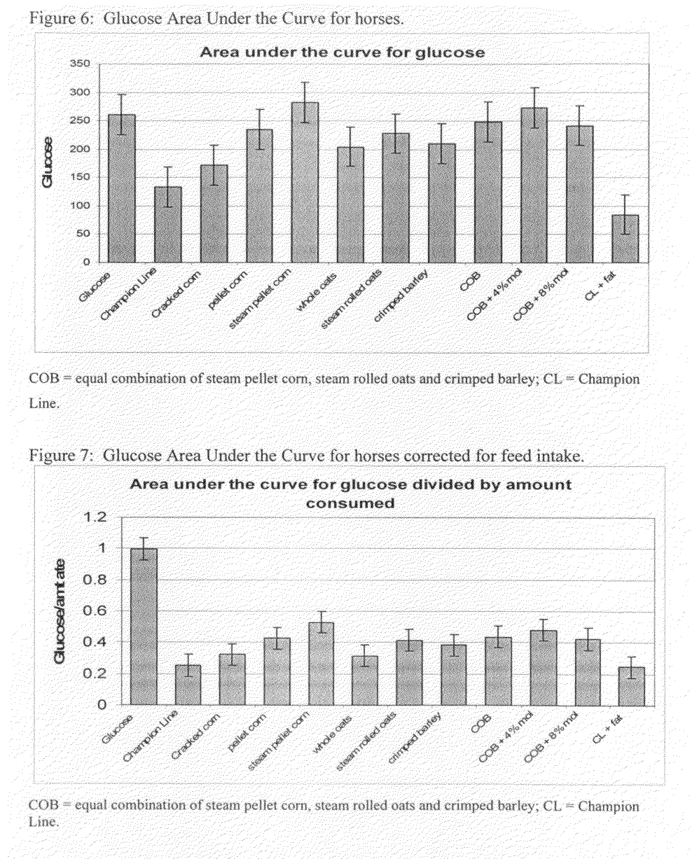

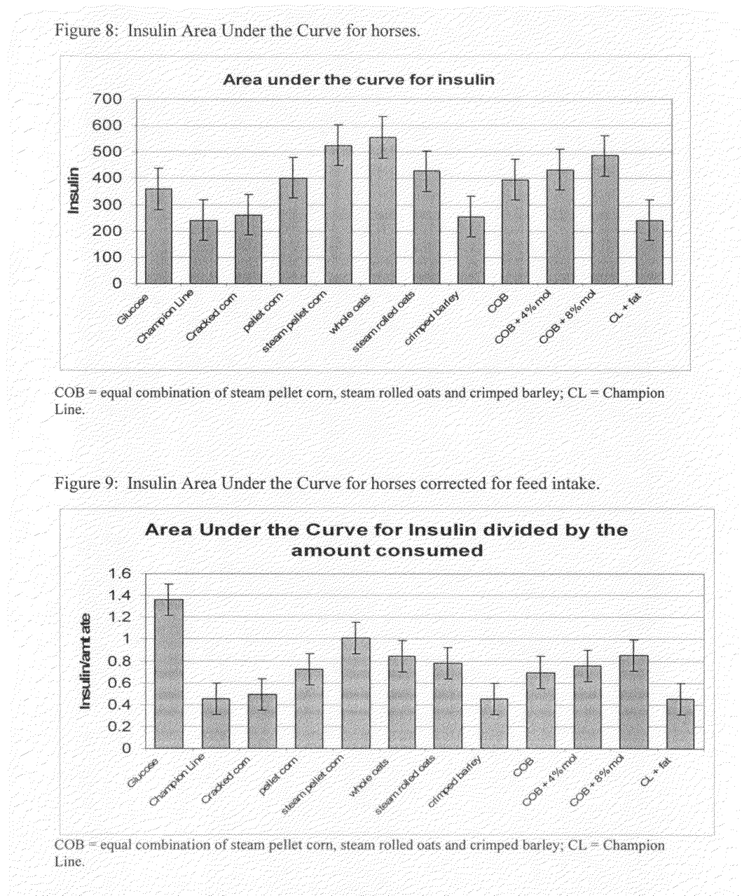

Table 9 and FIGS. 6, 7, 8, and 9 indicate the overall Area under the Curve (“AUC”) for glucose and insulin in horses fed the different ingredients as measured in the horse and adjusted for feed intake. Data was considered significant at P<0.10.

Horses fed Champion Line had a lower AUC relative to glucose, pellet corn, steam pellet corn, whole oats, steam rolled oats, crimped barley, COB (equal combination of steam pellet corn, steam rolled oats and crimped barley), or COB+molasses added at 4% or 8%. Also, horses fed Champion Line had a lower insulin AUC relative to Pellet corn, Steam Pellet Corn, Whole oats, steam rolled oats, or COB with 4% or 8% added molasses. When looking at the data on a feed intake bases horses fed Champion Line had a lower glucose AUC/intake value relative to those fed glucose, pellet corn, steam pellet corn, steam rolled oats, COB, and the COB+4% added molasses. Horses fed Champion Line had a lower insulin AUC/intake value relative to those fed pellet corn, steam pellet corn, whole oats, rolled oats, and the COB+4% or 8% added molasses.

TABLE 9
Glucose and insulin results for horses fed different ingredients.

| | Glucose | | Insulin | | | Insulin |
|---|---|---|---|---|---|---|
| Dietary | AUC | Glycemic | AUC, | Glucose | Glycemic | AUC- |
| Treatments | (mg/dliter) | Index | (U/dliter) | AUC-Intake¹ | Index | Intake² |
| Glucose | 260.6^{d} | 100 | 360.3^{ab} | 0.996^{a} | 100 | 1.363^{a} |
| Champion | 133.6^{ab} | 51 | 241.3^{a} | 0.252^{e} | 25 | 0.453^{e} |
| Line | | | | | | |
| Cracked corn | 171.9^{bc} | 66 | 262.5^{ac} | 0.323^{cde} | 32 | 0.492^{de} |
| Pellet corn | 235.0^{cd} | 90 | 401.9^{bcd} | 0.427^{bc} | 43 | 0.728^{cd} |
| Steam pellet | 282.8^{d} | 109 | 526.6^{de} | 0.530^{bc} | 53 | 1.008^{b} |
| corn | | | | | | |
| Whole oats | 204.9^{cd} | 79 | 555.9^{e} | 0.316^{cde} | 32 | 0.842^{bc} |
| Steam rolled | 228.2^{cd} | 88 | 427.5^{be} | 0.415^{bc} | 42 | 0.778^{bc} |
| oats | | | | | | |
| Crimped | 210.7^{cd} | 81 | 255.3^{a} | 0.384^{bde} | 39 | 0.457^{de} |
| barley | | | | | | |
| COB | 248.3^{d} | 95 | 3953^{abcd} | 0.437^{bc} | 44 | 0.696^{cde} |
| COB + 4% | 273.4^{d} | 105 | 433.2^{be} | 0.480^{b} | 48 | 0.754^{bc} |
| mol | | | | | | |
| COB + 8% | 241.8^{d} | 93 | 486.0^{be} | 0.425^{be} | 43 | 0.853^{bc} |
| mol | | | | | | |
| Champion | 85.0^{ab} | 33 | 241.8^{a} | 0.245^{e} | 25 | 0.455^{e} |
| Line + fat | | | | | | |
| SEM | 34.8 | | 80.1 | 0.075 | | 0.149 |

^{abcde}Means in a column with different superscripts differ P < 0.10. COB = equal combination of steam pellet corn, steam rolled oats and crimped barley
¹Glucose AUC-Intake was calculated by dividing the Glucose AUC by the feed intake.
²Insulin AUC-Intake was calculated by dividing the Insulin AUC by the feed intake.

These data support the conclusion that when fed to provide equal energy to the horse, horses fed Champion Line feed have lower glycemic and insulin responses relative to those fed corn or oats.

### Example 8

Starch Ileal Digestibility Trial 2. Ileal cannulated pigs were used in this study. A cannula was surgically placed at the ileal-cecal junction in pigs using approved procedures. Treatment diets were fed to pigs on an equal starch basis. The test diets were fed for 3 days and the ileal contents were collected at the end of the 3 days. Test contents were collected for 1 day. Then a common diet was fed for 4 days. Diets were ˜99% test ingredient with added vitamins, minerals, and titanium dioxide (indigestible marker). Ileal contents were freeze-dried and then analyzed for starch and titanium to determine the digestibility of the starch in each ingredient. For calculation of digestibility all diets were also analyzed for titanium and starch. Data was considered significant at P<0.10.

Starch digestibility is shown in Table 10. Starch digestibility was measured by measuring the amount of starch intake and the amount of starch found in the terminal ileum. Starch leakage values were determined by calculating the possible starch left over after eating 10 lbs of each respective product. Starch digestibility can be seen in Table 10. Pigs fed Champion Line or the Corn Pellet had a higher starch digestibility relative to those fed cracked corn or steam crimped barley. Also, pigs fed steam crimped barley had a lower starch digestibility relative to those fed whole oats. Pigs fed the steam crimped barley tended to have (P=0.13) have lower starch digestibility relative to those fed steam rolled oats. When this data is expressed on a starch leakage (lbs of starch that may leak to the hindgut per 10 lb of intake) pigs fed the cracked corn or the steam crimped barley had a higher risk of starch leakage than those fed the other ingredients. This trial agrees with data from a previous study, which indicated that Champion Line reduced the risk of starch leaking to the hindgut of pigs relative to corn products.

Composition of the ingredients can be seen in Table 11. As expected as the corn was processed (cracked versus pellet) the gelatinized starch content increased. This also can be seen in the whole oats, as the oats were processed the gelatinized starch content increased (more profound in the corn). As expected the gelatinized starch did not correlate to overall starch digestibility in the oats. However, in the corn products the higher starch digestibility was in the corn product that had the higher amount of starch gelatinization. This was probably due more to the enzymes not being able to reach the starch rather than a gelatinization itself. Gelatinization of starch normally increases the rate of digestion but does not always affect the overall amount of starch that is digested. The two factors that contribute to the amount of starch that can potentially leak to the hindgut are total starch in the ingredient and the digestibility of that starch.

TABLE 10
Dietary effects on growth performance.

| | | Leakage, lbs (per 10 lb |
|---|---|---|
| Dietary Treatments | Starch Digestibility, % | intake) |
| Champion Line | 95.77^{a} | 0.15^{b} |
| Cracked Corn | 84.66^{bc} | 1.04^{a} |
| Corn Pellet | 95.90^{a} | 0.28^{b} |
| Whole Oats | 91.28^{ab} | 0.44^{b} |
| Steam Rolled Oats | 90.38^{abc} | 0.46^{b} |
| Steam Crimped | 83.74^{c} | 0.99^{a} |
| Barley | | |

VARIATION

| | | |
|---|---|---|
| SEM | 2.96 | 0.16 |

Means with different superscripts differ, P < 0.07.

TABLE 11
Composition of the ingredients used for this trial.

| Dietary | CP, | FAT, | Moisture, | Ash, | NDF, | ADF, | Starch, | Gel Starch, |
|---|---|---|---|---|---|---|---|---|
| Treatments | % | % | % | % | % | % | % | %^{a} |
| Champion Line | 10.15 | 9.72 | 11.61 | 2.68 | 14.63 | 3.73 | 38.2 | 15.22 |
| Cracked Corn | 7.32 | 3.35 | 14.76 | 1.13 | 6.91 | 1.73 | 70.4 | 12.83 |
| Corn Pellet | 7.32 | 3.35 | 14.76 | 1.13 | 6.91 | 1.73 | 64.3 | 23.53 |
| Whole Oats | 10.84 | 3.71 | 10.67 | 2.52 | 24.66 | 10.74 | 53.9 | 18.48 |
| Steam Rolled Oats | 10.74 | 3.44 | 12.88 | 2.44 | 24.61 | 10.24 | 54.0 | 22.49 |
| Steam Crimped | 9.55 | 1.45 | 12.02 | 1.98 | 13.91 | 3.91 | 57.9 | 30.50 |
| Barley | | | | | | | | |

^{a}Gel Starch indicates the amount of gelatinized starch in the total diet.

This data indicates that there is more potential for starch leakage with the corn, oats, or barley products than with the Champion Line feed products.

Thus, when each animal is fed 10 lbs of each product, more starch is available to the ceacum and large intestine from the corn, oats, or barley products than from the Champion Line feed products. This results in a 86%, 46%, 66%, 67%, and 85% decrease in potential starch leakage in the Champion Line Expanded 1 feed product versus the cracked corn, corn pellet, whole oats, steam rolled oats, and steam crimped barley, respectively.

In this trial, Champion Line feed had both a lower GI and a higher potential for starch leakage based on the digestibility data than corn or the oat products. Accordingly, an evaluation of both glycemic response and potential starch leakage illustrates that

Champion Line feed products provide advantages over other feed grains.

### G. Illustrated Embodiments

The following illustrated embodiments are presented to aid the reader in understanding the compositions and methods described herein and are not intended to be limiting.

A first illustrated embodiment includes a corn-based feed component comprising at least about 75 wt. % of a combination of corn components, wherein the feed component comprises a total starch content of about 30-60 wt. % (DM1), and from about 7 wt. % to 20 wt. % fat (DMB), and wherein at least about 50% of the starch content is gelatinized starch.

A second illustrated embodiment includes a corn-based feed component comprising an omega 3 FA source and at least about 75 wt. % of a combination of corn components, wherein the combination of corn components comprises a total starch content of about 30-60 wt. % (DM1), from about 7 wt. % to 20 wt. % fat (DMB), and at least about 30% of the starch is gelatinized.

A third illustrated embodiment includes a feed comprising a corn-based feed component, wherein the corn-based feed component comprises at least about 75 wt. % of a combination of corn components, wherein the feed component comprises a total starch content of about 30-60 wt. % (DMB), from about 7 wt. % to 20 wt. % fat (DMB), and wherein at least about 50% of the starch content is gelatinized starch. A fourth illustrated embodiment includes a method of feeding a horse comprising feeding the horse a ration which comprises an extruded, corn-based feed component comprising at least about 75 wt. % of a combination of corn components, wherein the feed component comprises: a total starch content of about 30-60 wt. % (DMB), from about 7 wt. % to 20 wt. % fat (DMB), and wherein at least about 50% of the starch content is gelatinized starch.

A fifth illustrated embodiment includes a method of feeding a horse comprising feeding the horse a ration which comprises a pelleted, corn-based feed component comprising an omega-3 FA source and at least about 75 wt. % of a combination of corn components, wherein the combination comprises: a total starch content of about 30-60 wt. % (DMB), from about 7 wt. % to 20 wt. % fat (DMB), and at least about 30% of the starch is gelatinized.

A sixth illustrated embodiment includes a feed component formed by the process of pelleting a combination of corn components to provide a pelleted feed component, wherein the feed component comprises at least about 75 wt. % of a combination of corn components, and wherein the combination of corn components comprises: a total starch content of about 30-60 wt. % (DMB), about 7 wt. % to 20 wt. % fat (DMB); and at least about 30% of the starch is gelatinized.

A seventh illustrated embodiment includes a feed component formed by the process of extruding a combination of corn components to provide an extruded feed component, wherein the feed component comprises at least about 75 wt. % of a combination of corn components, and wherein the combination of corn components comprises: a total starch content of about 30-60 wt. % (DMB), from about 7 wt. % to 20 wt. % fat (DMB), and at least about 50% of the starch is gelatinized.

An eighth illustrated embodiment includes a feed component by the process of expanding a combination of corn components to provide an expanded feed component, wherein the feed component comprises at least about 75 wt. % of a combination of components, and wherein the combination of components comprises: a total starch content of about 30-60 wt. % (DMB), from about 7 wt. % to 20 wt. % fat (DMB), and at least about 50% of the starch is gelatinized.

A ninth illustrated embodiment includes a feed comprising a corn-based feed component, wherein the corn-based feed component comprises an omega-3 FA source and at least about 75 wt. % of a combination of corn components, wherein the combination of corn components comprises: a total starch content of about 30-60 wt. % (DMB), from about 7 wt. % to 20 wt. % fat (DMB), and wherein at least about 30% of the starch content is gelatinized starch.

It will be readily apparent to one skilled in the art that varying substitutions and modifications may be made to the methods and compositions disclosed herein without departing from the scope and spirit of such methods and compositions. The methods and compositions illustratively described herein suitably may be practiced in the absence of any element or elements, limitation or limitations which is not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the methods and compositions. Thus, it should be understood that although the present methods and compositions have been illustrated by specific embodiments and optional features, modification variation of the concepts herein disclosed may be resorted to by those skilled in the art, and that such modifications and variations are considered to be within the scope of the disclosed methods and compositions.

What is claimed is:

1. A corn-based feed component comprising at least about 75 wt. % of a combination of corn components,
wherein the feed component comprises:
a total starch content of about 30-60 wt. % (DMB), from about 7 wt. % to 20 wt. % fat (DMB); and
wherein at least about 50% of the total starch content is gelatinized starch.

2. The feed component of claim 1 having a crude protein content of at least about 10 wt. % (DMB).

3. The feed component of claim 2 wherein the crude protein content is from about 10-15 wt. % (DMB).

4. The feed component of claim 1 having a fiber content of at least about 10 wt. % (DMB).

5. The feed component of claim 1 having an ash content of at least about 1.5 wt. % (DMB).

6. The feed component of claim 1, wherein said feed component has an acid detergent fiber content of at least about 2.5 wt. % (DMB); and a neutral detergent fiber content of at least about 11 wt. % (DMB).

7. The feed component of claim 1 further comprising an additional source of trace nutrients.

8. The feed component of claim 1 further comprising an additional source of fat.

9. A corn-based feed component comprising an omega-3 FA source and at least about 75 wt. % of a combination of corn components,
wherein the combination of corn components comprises:
a total starch content of about 30-60 wt. % (DMB),
from about 7 wt. % to 20 wt. % fat (DMB); and
at least about 30% of the total starch content is gelatinized.

10. The feed component of claim 9, wherein at least about 50% of the total starch content is gelatinized.

11. The feed component of claim 9 further comprising an additional source of trace nutrients.

12. The feed component of claim 9 further comprising at least one of:
a calcium source, a zinc source and a selenium source.

13. The feed component of claim 9 further comprising an additional source of fat.

14. The feed component of claim 9, wherein the omega-3 FA source comprises fish oil.

15. The feed component of claim 14, comprising at least about 1 wt. % (DMB) of the fish oil.

16. The feed component of claim 9, comprising at least about 5 wt. % (DMB) of the omega-3 FA source.

17. The feed component of claim 1, wherein a glycemic response of the feed component is comparable to a glycemic response of rolled oats.

18. The feed component of claim 9, wherein a glycemic response of the feed component is comparable to a glycemic response of rolled oats.

19. The feed component of claim 1, wherein the feed component has a glycemic index based on equal feed intake which is no greater than a glycemic index based on equal feed intake of rolled oats.

20. The feed component of claim 9, wherein the feed component has a glycemic index based on equal feed intake which is no greater than a glycemic index based on equal feed intake of rolled oats.

21. The feed component of claim 1, wherein said feed component comprises about 5 ppm or less fumonisin.

22. The feed component of claim 9, wherein said feed component comprises about 5 ppm or less fumonisin.

23. A feed comprising:
a corn-based feed component, wherein the corn-based feed
component comprises at least about 75 wt. % of a combination of corn components,
wherein the feed component comprises:
a total starch content of about 30-60 wt. % (DMB),
from about 7 wt. % to 20 wt. % fat (DMB); and
wherein at least about 50% of the total starch content is gelatinized starch.

24. The feed of claim 23, wherein the corn-based feed component further comprises an omega-3 FA source.

25. The feed component of claim 9, wherein said feed component consists essentially of a pelleted combination of corn components.

26. The feed component of claim 25, wherein the combination has:
a total starch content of about 30-60 wt. % (DMB);
from about 7 wt. % to 15 wt. % fat (DMB);
a crude protein content of at least about 10 wt. % (DMB);
an acid detergent fiber content of at least about 2.5 wt. % (DMB);
a neutral detergent fiber content of at least about 11 wt. % (DMB); and
an ash content of at least about 2 wt. % (DMB).

27. The feed component of claim 1, wherein said feed component consists essentially of an extruded combination of corn components.

28. The feed component of claim 27, wherein the combination has:
a total starch content of about 30-60 wt. % (DMB);
from about 7 wt. % to 15 wt. % fat (DMB);
a crude protein content of at least about 10 wt. % (DMB);
an acid detergent fiber content of at least about 2.5 wt. % (DMB);
a neutral detergent fiber content of at least about 11 wt. % (DMB); and
an ash content of at least about 2 wt. % (DMB).

29. The feed component of claim 1, wherein said feed component consists essentially of an expanded combination of corn components.

30. The feed component of claim 29, wherein the combination has:
a total starch content of about 30-60 wt. % (DMB);
from about 7 wt. % (DMB) to 15 wt. % fat (DMB);
a crude protein content of at least about 10 wt. % (DMB);
an acid detergent fiber content of at least about 2.5 wt. % (DMB);
a neutral detergent fiber content of at least about 12 wt. % (DMB); and
an ash content of at least about 2 wt. % (DMB).

31. A method of feeding a horse comprising:
feeding the horse a ration which comprises an extruded, corn-based feed component comprising at least about 75 wt. % of a combination of components,
wherein the feed component comprises:
a total starch content of about 30-60 wt. % (DMB),
from about 7 wt. % to 20 wt. % fat (DMB); and
wherein at least about 50% of the total starch content is gelatinized starch.

32. A method of feeding a horse comprising:
feeding the horse a ration which comprises a pelleted, corn-based feed component comprising an omega-3 FA source and at least about 75 wt. % of a combination of corn components,
wherein the combination comprises:
a total starch content of about 30-60 wt. % (DMB),
from about 7 wt. % to 20 wt. % fat (DMB); and
at least about 30% of the total starch content is gelatinized.

33. A feed component formed by a process comprising pelleting a mixture, which includes corn components, to provide a pelleted feed component,
wherein the pelleted feed component comprises at least about 75 wt. % of a combination of corn components,
and the combination of corn components comprises:
a total starch content of about 30-60 wt. % (DMB);
from about 7 wt. % to 20 wt. % fat (DMB); and
at least about 30% of the total starch content is gelatinized.

34. A feed component formed by a process comprising extruding a mixture, which includes corn components, to provide an extruded feed component,
wherein the extruded feed component comprises at least about 75 wt. % of a combination of corn components,
and the combination of corn components comprises:
a total starch content of about 30-60 wt. % (DMB);
from about 7 wt. % to 20 wt. % fat (DMB); and
at least about 50% of the total starch content is gelatinized.

35. A feed component formed by a process comprising expanding a mixture, which includes corn components, to provide an expanded feed component,
wherein the expanded feed component comprises at least about 75 wt. % of a combination of corn components,
and the combination of corn components comprises:
a total starch content of about 30-60 wt. % (DMB);
from about 7 wt. % to 20 wt. % fat (DMB); and
at least about 50% of the total starch content is gelatinized.

36. The feed component of claim 33, wherein the process further comprises adding an omega-3 FA source to the pelleted feed component.

37. The feed component of claim 34, wherein the process further comprises adding an omega-3 FA source to the extruded feed component.

38. The feed component of claim 35, wherein the process further comprises adding an omega-3 FA source to the expanded combination.

39. The feed component of claim 33, wherein the corn components in the mixture have a granulation of less than about 1% by weight (DMB) on a 12 US mesh screen and at least about 90% by weigh (DMB) on a 60 US mesh screen.

40. The feed component of claim 34, wherein the corn components in the mixture have a granulation of less than about 1% by weight (DMB) on a 12 US mesh screen and at least about 90% by weigh (DMB) on a 60 US mesh screen.

41. The feed component of claim 35, wherein the corn components in the mixture have a granulation of less than about 1% by weight (DMB) on a 12 US mesh screen and at least about 90% by weigh (DMB) on a 60 US mesh screen.

42. The feed component of claim 33, wherein said feed component comprises about 5 ppm or less fumonisin.

43. The feed component of claim 34, wherein said feed component comprises about 5 ppm or less fumonisin.

44. The feed component of claim 35, wherein said feed component comprises about 5 ppm or less fumonisin.

45. The method of claim 31, wherein the feed component is provided as a feed supplement.

46. The method of claim 32, wherein the feed component is provided as a feed supplement.

47. The method of claim 31, wherein the feed component is provided as a feed additive.

48. The method of claim 32, wherein the feed component is provided as a feed additive.

49. The feed component of claim 1 having a potential starch leakage which is less than a potential starch leakage for whole corn.

50. A feed comprising:
a corn-based feed component, wherein the corn-based feed component comprises an omega-3 FA source and at least about 75 wt. % of a combination of corn components,
wherein the combination of corn components comprises:
a total starch content of about 30-60 wt. % (DMB),
from about 7 wt. % to 20 wt. % fat (DMB); and
wherein at least about 30% of the total starch content is gelatinized starch.
